(19) United States
(12) Patent Application Publication
(10) Pub. No.: US 2026/0273844 A1
(43) Pub. Date: Sep. 17, 2026

(54) MATERIAL EXTRUSION SYSTEM AND DEVICE USING THE SAME

(71) Applicant: Fabrice Gabriel Coutaz, Genève (CH)

(72) Inventor: Fabrice Gabriel Coutaz, Genève (CH)

(21) Appl. No.: 19/168,858

(22) PCT Filed: Oct. 12, 2023
(86) PCT No.: PCT/EP2023/078399

§ 371 Date: Sep. 25, 2025

(30) Foreign Application Priority Data
Mar. 29, 2023 (EP) 23165049.0

(51) Int. Cl. B29C 64/209; B29C 48/02; B29C 48/86; B29C 64/118; B29C 64/295; B33Y 30/00

(52) U.S. Cl. CPC B29C 64/209; B29C 48/02; B29C 48/865; B29C 64/118; B29C 64/295; B33Y 30/00

(57) ABSTRACT

A material extrusion head (100) comprising a tube portion (10) including a material feeding path adapted to receive some extrusion material from one or multiple reservoirs on one proximal end and exit said extrusion material nozzle on one distal end, a heat source adapted to generate heat and transmit said heat to the extrusion material passing through the tube portion by conduction and convection through the tube portion, wherein the tube portion presents an irregular inner surface comprising at least one protrusion within the material feeding path using interlocking elements to lock in place the extrusion material nozzle without the use of tools.

### TECHNICAL FIELD

The present invention relates to any material extrusion system and more particularly to a material extrusion system for a 3D printing device and even more preferably to a material extrusion head using the same for a material extrusion 3D printing device.

### BACKGROUND OF THE ART

Nowadays, 3D printing has become one the most popular process for fabricating objects. 3D printers are additive manufacturing machines that specialize in making custom parts with accuracy. They are classified as “additive” because they build up objects one layer at a time. Specialized software “slices” a 3D model into layers as thin from 0.05 mm for fused printers, to 0.01 mm for SLA processes. These layers are then deposited by the print process, slowly building up a 3D object.

More particularly, 3D printers add material, layer-by-layer, to form a 3D object. This added material can vary among dozens of plastic variations, with additives like metal powder, and even carbon fiber composites which is extruded through a nozzle opening to constitute the layers.

However, the conventional print heads present several drawbacks. Among them, the two major drawbacks are the replacement of the material feeding portions when needed and the heat transfer quality from the heating block to the material.

In fact, these two aspects require contrary features. The heat transfer requires close contact between the feeding path and the heating block while replacement of the material feeding element would require the least fixing/contact element among these components.

Basically, a user desires to modify the thickness and width of the extruded material in order to realize layers with different heights and thicknesses or because some clogs appeared in the melting path he would need to change or remove the end part called the nozzle and change it by another nozzle. In order to do so, the threaded nozzle that brings low thermal conduction usually has to be dismantled with tools.

Nowadays, nozzles are getting complex and can be changed without tools by screwing them hand tight. This means also having a sufficient gap between the cylindrical heater and the nozzle to remove them to avoid gripped parts, this gap brings heat radiation, not heat conduction.

In addition to that, one of the most important aspects in a print head is the thermal management which should provide the best heat conduction to the feeding material all the way long. However, with most current heads, at high flow, the heat transferred from the heat source to the material never reaches the center of the material filament which creates an enormous drawback since this means that the extrusion material filament is never fully molten.

There is therefore a need for a system permitting a high and rapid heat transfer preferably by conduction from a heat source to the totality of the feeding material path.

In addition to that, an important aspect in a print head is the thermal management which should provide a very high thermal resistance between the heat source and the rest of the print head to reduce thermal creep in the print head.

There is therefore a need for a system permitting a high heat resistance between the heat source and the rest of the print head using a very thin tube, called heat break tube.

Also, one of the most important aspect in a print head is the thermal management which should provide simultaneously a very high heat conduction transfer from a heat source to the feeding material to melt it and a very high thermal resistance between the heat source and the rest of the print head to reduce thermal creep in the print head.

There is therefore a need for a system permitting a high heat transfer from a heat source to the feeding material and a high heat resistance from the heat source and the rest of the print head.

Also, since the material will reach preferably a liquid or at least a viscous form along the path, it is crucial to have a reliable sealing capacity along the feeding path.

There is therefore a need for an extrusion system including a material extrusion head comprising a nozzle providing high sealing capacity along the material path thanks to the relation between the different elements but also the possible shapes of the elements used.

As mentioned above, dismantling, and then reassembling a nozzle or a print head using the same constitutes a cumbersome process and lack of reliability on ensuring a proper sealing capacity upon reassembling.

There is therefore also a need for a light extrusion system comprising an actioning system and/or fixing/fastening means which easily, reliably, and reversibly permit assembling and disassembling a material extrusion head comprising a nozzle.

### SUMMARY OF THE INVENTION

The above problems are solved by the present invention, which is a material extrusion system comprising an arrangement permitting an easy and rapid replacement of the nozzle without dismantling the entire print head, a heat transfer management permitting to conduct heat rapidly, efficiently and easily to the whole flowing material path, and an easy dismounting procedure without tools and no thread of the material extrusion head comprising the nozzle with this arrangement to reduce the dismantling time.

A first aspect of the invention is a material extrusion head comprising a tube portion including a material feeding path adapted to receive some extrusion material from one or multiple reservoirs on one proximal end and to exit said extrusion material on one distal end, a heat source adapted to generate heat and transmit said heat to the extrusion material passing through the tube portion by conduction through the tube portion, characterized in that the tube portion presents an irregular inner surface comprising at least one protrusion within the material feeding path.

Preferably, the at least one protrusion is provided by compression onto discrete positions of the outer surface of the tube portion so as to keep a general cylinder shape of its outer wall.

Advantageously, the distal end comprises an extrusion nozzle.

In addition, the extrusion nozzle consists in a single extrusion nozzle integrated, clipped, screwed, inserted, welded or crimped to the tube portion or is cast in a single piece with said tube portion. In this manner, there is no thread.

In a preferred manner, the tube portion is chosen from the group comprising a rolled tube, machined tube, extruded tube, printed tube and a melted tube.

According to a preferred embodiment of the present invention, the tube portion includes a heat break tube, preferably a crimped heat break tube.

Preferably, the heat source is a heating block made of at least two movable heating block portions movable relative to each other so as to clamp to the tube portion.

In addition, the heating block is provided with elastic means adapted to provide an elastic force urging the two movable heating block portions against each other such that the at least two movable heating block portions are sandwiching the tube portion for an optimum heat conduction.

According to a preferred embodiment of the present invention, the distal and proximal ends both are adapted to protrude from the heating block when housed within it.

Preferably, each movable heating block portion is provided with an inner bore presenting a shape corresponding to the tube portion such that when the two movable heating block portions are urged against each other, preferably at least one of the two facing bores create a housing presenting a shape corresponding to the one of tube portion.

Advantageously, the movable heating portions are ceramic portions adapted to surround and lock the tube portion within it and integrate the fixing means of the extrusion head.

According to a preferred embodiment of the present invention, preferably at least one of the heating block (20) and the tube portion is further provided with an annular groove and a protrusion corresponding to each other respectively.

In a preferred manner, the material extrusion head further comprises a holding structure comprising a component for feeding some extrusion material from one or multiple reservoirs to the tube portion.

The holding structure comprises at least one of an outlet of a material feeding tube, a heat sink, a support, electronics, the reservoirs, and the same.

Advantageously, the proximal end is adapted to be inserted into a heat sink upon locking the heat break tube and tube portion within the heat block so as to provide a sealed and tight extrusion material path.

According to a preferred embodiment of the present invention, the proximal end of the tube portion is provided with an annular groove or shouldering interlocking with said holding structure.

Preferably, the holding structure, the support element, the tube portion, and the heating blocks are adapted to be detachably mounted together with interlocking or clamping elements without any tools needed or screw.

A second aspect of the invention is a printing device comprising the head according to the first aspect. Preferably, the device is a 3D printing device or any device that would melt material into a path to increase melting efficiency of the core material.

### BRIEF DESCRIPTION OF THE DRAWINGS

Further particular advantages and features of the invention will become more apparent from the following non-limitative description of the embodiments of the invention which will refer to the accompanying drawings, wherein

FIG. 1 represents a side view of the material extrusion head according to a preferred embodiment of the present invention;

FIGS. 2A and 2B represent perspective views of the material extrusion head according to a preferred embodiment of the present invention;

FIGS. 3A to 3E represent side views of tube portions according to preferred embodiments of the present invention;

FIG. 4 represents a vertical cut view of a tube portion according to a preferred embodiment of the present invention;

FIGS. 5A to 5C represent perspective views of a short and a long tube portions according to preferred embodiments of the present invention installed within a nozzle of the prior art;

FIGS. 6A and 6B represent views of different fixing solutions of the heat block clamping mechanism of the tube portion.

### DETAILED DESCRIPTION OF THE INVENTION

The present detailed description is intended to illustrate the invention in a non-limitative manner since any feature of an embodiment may be combined with any other feature of a different embodiment in an advantageous manner.

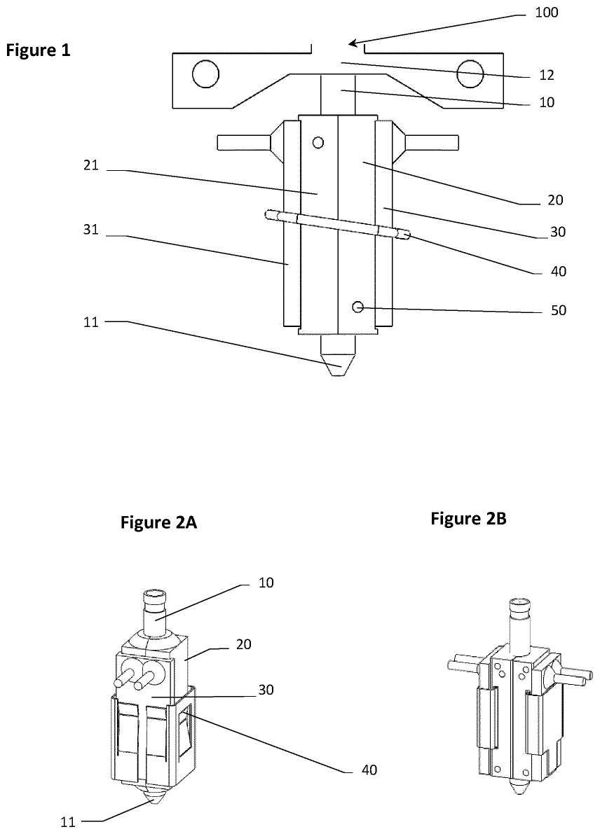

FIGS. 1 and 2 show an aspect of the invention, which is a material extrusion system or device according to a first embodiment.

More particularly it relates to a material extrusion head 100 comprising a tube portion 10, being one of a rolled tube, machined tube, extruded tube, printed tube and a melted tube, including a material feeding path 14 adapted to receive some extrusion material from one or multiple reservoirs on one proximal end 12 and exit said extrusion material through an extrusion nozzle on one distal end 11, a heat source 20 adapted to generate heat and transmit said heat to the extrusion material passing through the tube portion 10 by conduction, radiation and convection through the tube portion.

Preferably, the tube portion 10 presents an irregular inner surface comprising at least one protrusion 13 within the material feeding path wherein the one protrusion 13 is provided by compression onto discrete positions of the outer surface of the tube portion 10 so as to keep a general cylinder shape of its outer wall.

The heat source 20 is a heating block made of at least two movable heating block portions 21 movable relative to each other so as to clamp to the tube portion 10.

As shown in FIGS. 6A and 6B, in order to be able to clamp the tube portion, both heating block portions 21 are preferably fixed to the holding structure 100 so as to pivot between an open position (6A) and a closed position(6B) In order to be able to pivot, a preferred embodiment is to mount each block portion 21 on a frame 31 presenting a loop 311 portion or an aperture at an end and to make an aperture 101 having C-shape, T-shape or U-shape on the holding structure 100 such that it presents a tongue which can be inserted in the loop portion of the frame.

According to a preferred embodiment, the block portion can be mounted on the frame via a rail of the frame cooperating with a groove of the block and an isolating material can be integrated between the holding structure and the heating portions to minimize heat transfer.

In order to maintain a certain pressure and thereby lock the tube portion between the two potions 21, the heating block 20 is provided with an elastic means 40 adapted to provide an elastic force urging the two movable heating block portions 21 against each other such that the at least two movable heating block portions 21 are sandwiching the tube portion 10 when provided in between. In order to enhance heat transfer, each movable heating block portion 21 is provided with an inner bore presenting a shape to partially fit the outer shape of the tube portion 10 such that when the two movable heating block portions 21 are urged against each other, preferably at least one of the two facing bores create a housing presenting a shape corresponding to the one of tube portion 10. Also preferably at least one of the heating block 20 and the tube portion 21 is further provided with grooves and protrusions corresponding to each other respectively permitting to position the tube within the heating block.

The device of the present invention further comprises a holding structure comprising an outlet of a material feeding tube, an extruder, a heat break tube, a heat sink, a support, electronics and the reservoirs, all of them not being shown in the figures for clarity reasons.

The material feeding tube is a component for feeding some extrusion material from one or multiple reservoirs to the tube portion 10 located inside the heating source 20. The material feeding tube can be any type of tube, preferably made of a soft material for an easy handling of the same which connects a material reservoir to the extrusion system.

FIGS. 1 and 2A and 2B show the heating block 20 clipped around the tube portion 10 and adapted to be detachably mounted to it with clipping elements without any tools needed or screw.

The heating block 20 is preferably made of copper, of a thermally conductive metal or of ceramic heating elements and preferably comprises bores able to receive one or more heating elements 30 and a thermocouple 50. In FIG. 2B, the heating elements are shown as being two, one on each heating block portion, however the invention comprises the options such as a single heating element mounted on both heating block position 21 as shown in FIG. 2A. Also, the heating elements can be mounted on either side, or both sides of one or each movable heating block together to increase heating efficiency.

Of course the term heating element means at least one heating element and it is important to note here that bores are not necessarily horizontal but can be vertical, parallel or perpendicular to the material feeding direction. The heating block is provided with fastening elements as shown in FIGS. 1, 2, capable of fixing it to the holding structure in a detachable manner, also possibly acting as a cooling element, these fastening elements can have different shapes such as flat plates or round wires, or the same.

The heating element can be an induction heater, twisted around the tube, in a C shape, circular, inserted on the tube when replacing the nozzle.

The tube portion 10 is adapted to be installed and removed in/from the housing of the heating block 20 and adapted to conduct the heat provided through the heating block 20 to the extrusion material passing through it.

The tube portion 10 and heating block 20 cooperate in such a way that in the open position the at least two portions 21 are distant from each other such that the tube portion 1 can slide in the housing and in the closed position the at least two portions 21 are sandwiching the tube portion 10 such that it is locked within the housing 20 presenting a shape corresponding to the tube portion so as to maximize the contact between the heating block and the tube to enhance heat transfer. Adding thermal paste can improve heat conductivity between parts.

According to a preferred embodiment as shown in FIGS. 6A and 6B, the tube portion 10 may comprise a particular profile, such as an annular shouldering 15, which comes against a lower (or upper surface depending on the perspective) surface 22 of each two portions 21 such that upon clamping the tube portion 10 the two portions 21 also apply an urging force by the rotational movement onto the tube 10 which urges it against the holding structure 100, preferably the heat sink held by holding structure so as to provide a sealed extrusion material path This urging clamping force is also generating a tight and ridged assembly of the nozzle.

According to the preferred embodiment shown in FIGS. 1 and 2, the actioning system 40 is a spring clamped to each movable portion of the heating block so as to be adapted to tighten them against each other with respect to the other one. Alternatively, the actioning system can be any other deported actioning system carrying out the same function.

The heating block can be further provided with an annular groove having a depth larger than the cylindrical housing to receive an annular protrusion of the tube portion which can assure positioning and retaining within the heating block.

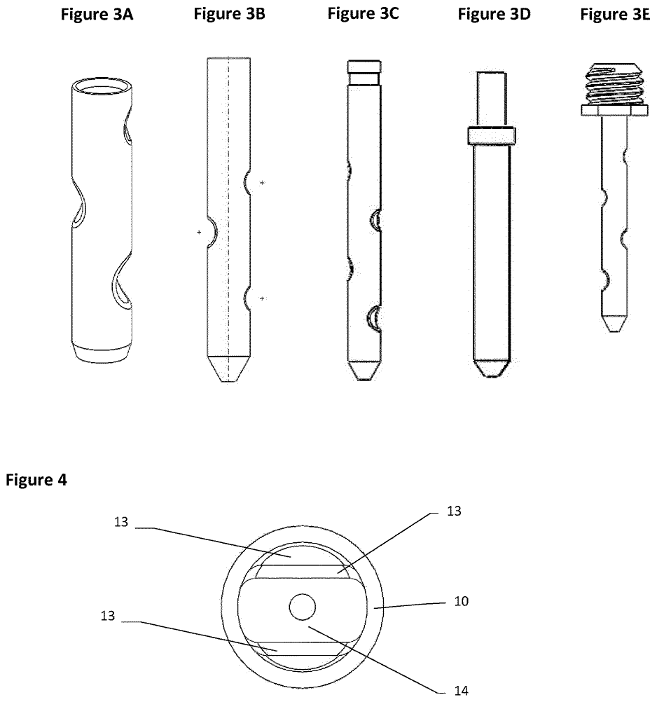

FIGS. 3A to 3E show different embodiments of the tube portion 10.

The common aspect among them is that the tube portion 10 presents an irregular inner section, although from the figures only the outer surface is shown, comprising at least one protrusion 13 within the material feeding path. These figures show the protrusions provided by compression onto discrete positions of the outer surface of the tube to keep the cylinder shape of the outer wall. However, different methods can be employed, and the outer shape can remain unchanged while the inner path is modified punctually or along the tube.

The tube portion 10 comprises a distal end 11 and a proximal end 12 both being adapted to protrude from the heating block 20 when housed within it as shown in FIGS. 1 and 2. The proximal end 12 with the integrated heat break tube, is adapted to be fixed or urged against the holding structure 100, preferably a heat sink held by holding structure, upon locking the tube portion 12 within the heat sink so as to provide a sealed extrusion material path, while the distal end 11 comprises an extrusion nozzle cast in a single piece with said tube. Alternatively, the extrusion nozzle 11 may consist in a separated extrusion nozzle fixed, clipped, screwed, inserted, welded, rolled or crimped to the tube portion end.

As shown in FIG. 3C, the proximal end 12 of the tube portion 10 can show an annular groove 120 adapted to be inserted within the above-mentioned annular groove of the heat sink when installed. The annular groove can be a shouldering.

As shown in FIG. 3D, the tube portion may show a threaded section adapted to be screwed into the above-mentioned heat sink when installed.

As shown in FIG. 3E, the tube portion may show a crimped, glued, welded threaded section adapted to be inserted within the above-mentioned heat sink when installed.

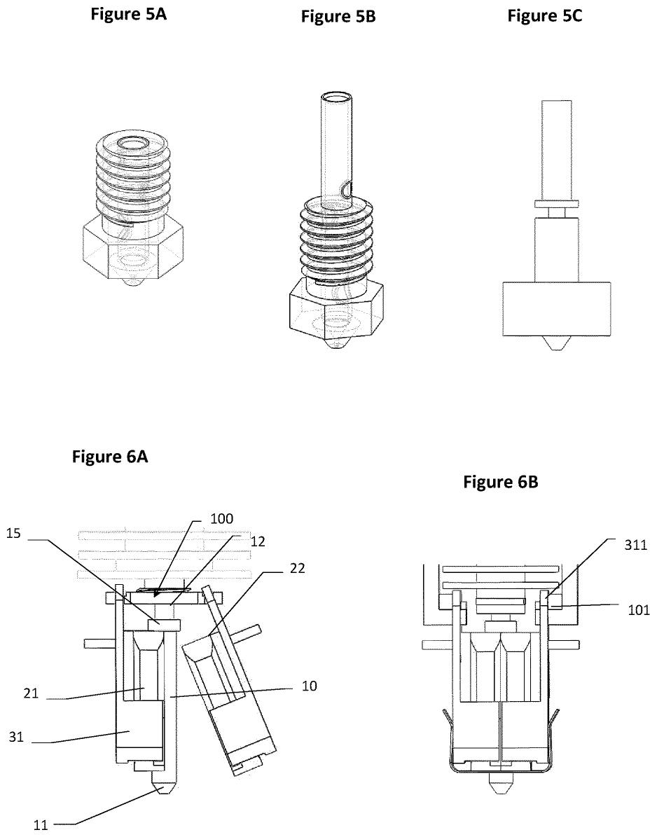

As shown in FIGS. 5a and 5B, the tube portion 10 with the protrusions can be easily inserted or crimped into a usual nozzle with an adapted hole dimension when installed. To fill the gap of the protrusion, the inserted tube can be done in a reservoir with copper powder such as the powder will fill in the gap when inserted, crimped this will improve thermal conduction.

It has further to be noted that the protrusion on a section of the tube can be inserted, crimped into an existing nozzle, into a heating block and nozzle, into a heat break tube or any section where there is a melting functionality of the material. Also, the tube with the protrusions can be in many different materials, to name a few, stainless steel, hardened steel, copper, brass. This tube can be a small section of the melting path, as well as a combined full heat break tube, heating tube and nozzle in a single or different materials.

A second aspect of the invention is a printing device using the extrusion head described above. Preferably, the printing device is a 3D printing device. In such a device, the tube portions can be arranged in a row or circular like a carrousel on the side or the back of the print bed and rotated with its own mechanism. The print head mechanism can move the heating block so as to grab the desired tube and bring it to the printing position. The advantage of such a system is that the heating element is not on the tube when put aside, not degrading the material, as the tube would cool down very quickly due to its low mass.

While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the scope of this disclosure. This for example particularly the case regarding the diameters used, the type of material inserted in the tube to form the extrusion diameter, the shape of the support, the type of fixing mechanism, the material extruded, the material, the thermal treatment and coating of the nozzles, of the tube and the like.

1. Material extrusion head (100) comprising
a tube portion (10) including a material feeding path (14) adapted to receive some extrusion material from one or multiple reservoirs on one proximal end (12) and exit said extrusion material on one distal end (11),
a heat source (20) adapted to generate heat and transmit said heat to the extrusion material passing through the tube portion (10),
characterized in that
the tube portion (10) presents an irregular inner surface comprising at least one protrusion (13) within the material feeding path.

2. Material extrusion head according to claim 1, characterized in that the at least one protrusion (13) is provided by compression onto discrete positions of the outer surface of the tube portion (10) so as to keep a general cylinder shape of its outer wall.

3. Material extrusion head according to claims 1 or 2, characterized in that the distal end (11) comprises an extrusion nozzle.

4. Material extrusion head according to claim 3, characterized in that the extrusion nozzle (11) consists in a single extrusion nozzle integrated, clipped, screwed, inserted, rolled, welded or crimped to the tube portion or is cast in a single piece with said tube portion.

5. Material extrusion head according to any one of claims 1 to 4, characterized in that the tube portion (10) is chosen from the group comprising a rolled tube, machined tube, extruded tube, printed tube and a melted tube.

6. Material extrusion head according to any one of claims 1 to 5, characterized in that the proximal end of the tube portion (10) has an integrated crimped heat break tube that can be of similar or different material than the tube portion.

7. Material extrusion head according to any one of claims 1 to 6, characterized in that the heat source (20) is a heating bock made of at least two movable heating block portions (21) movable relative to each other so as to clamp to the tube portion for heat conduction (10).

8. Material extrusion head according to claim 7, characterized in that the heating block (20) is provided with an elastic means (40) adapted to provide an elastic force urging the two movable heating block portions (21) against each other such that the at least two movable heating block portions (21) are sandwiching the tube portion (10).

9. Material extrusion head according to any one of claims 7 to 8, characterized in that each movable heating block portion (21) is provided with an inner bore presenting a shape corresponding to the tube portion (10) such that when the two movable heating block portions (21) are urged against each other, the two facing bores create a housing presenting a shape corresponding to the one of tube portion (10).

10. Material extrusion head to any one of claims 7 to 9, characterized in that the movable heating portions (21) are ceramic portions adapted to surround and lock the tube portion (10) within it.

11. Material extrusion head according to any one of claims 7 to 10 characterized in that at least one of the heating block (20) and the tube portion (21) is further provided with an annular groove and a protrusion corresponding to each other respectively.

12. Material extrusion head according to any one of claims 1 to 11, characterized in that it further comprises a holding structure (100) comprising a component for feeding some extrusion material from one or multiple reservoirs to the tube portion (10).

13. Material extrusion head according to claim 12, characterized in that the holding structure (100) comprises at least one of an outlet of a material feeding tube, a heat break tube, a heater, a heat sink, an extruder, a support, electronics, the reservoirs, and the same.

14. Material extrusion head according to claim 13, characterized in that the proximal end (12) is adapted with an integrated heat break tube to be inserted into a heat sink upon locking the tube portion (10) within the heat block and clamping element so as to provide a sealed extrusion material path.

15. Material extrusion head according to any one of claims 10 to 14 characterized in that the proximal end (12) of the tube portion (10) is provided with an annular groove or shouldering (120) interlocking with said holding structure.

16. Material extrusion head according to any one of claims 12 to 15, characterized in that the support element, the tube portion with the integrated heat break tube and the heating block are adapted to be detachably mounted together with interlocking or clamping elements without any tools needed or screw.

17. Printing device comprising the extrusion head according to any one of claims 1-16.

18. Printing device according to claim 17, where the device is a 3D printing device.

19. Material extrusion head according to any one of claims 13 to 16, characterized in that the holding structure, the tube portion, and the heating block are adapted to be detachably mounted together with interlocking or clamping elements without any tools needed or screw.
